(19) United States
(12) Patent Application Publication
(10) Pub. No.: US 2025/0148907 A1
(43) Pub. Date: May 8, 2025

(54) METHOD OF PREDICTING HOLIDAY EXPRESSWAY TRAVEL TRAFFIC VOLUME BASED ON INFLUENCE OF WEATHER FACTORS

(71) Applicant: SHENZHEN URBAN TRANSPORT PLANNING CENTER CO., LTD., SHENZHEN (CN)

(72) Inventors: XIAOCHUN ZHANG, SHENZHEN (CN); TAO LIN, SHENZHEN (CN); MUPING LI, SHENZHEN (CN); ZHENWU CHEN, SHENZHEN (CN); XING LIU, SHENZHEN (CN); YONG ZHOU, SHENZHEN (CN); JIACHEN LUO, SHENZHEN (CN)

(21) Appl. No.: 18/951,550

(22) Filed: Nov. 18, 2024

Related U.S. Application Data
(63) Continuation of application No. PCT/CN2024/111197, filed on Aug. 9, 2024.

(30) Foreign Application Priority Data
Nov. 2, 2023 (CN) 202311442757.1

(51) Int. Cl. G08G 1/01; G06N 3/084

(52) U.S. Cl. CPC G08G 1/0129; G06N 3/084; G08G 1/0116; G08G 1/0133

(57) ABSTRACT

Disclosed is a method of predicting a holiday expressway travel traffic volume based on influence of weather factors. The method includes: establishing a relative influence coefficient between historical weather and a travel traffic volume; constructing a travel traffic volume transfer model based on weather data; selecting basic characteristics of the travel traffic volume, constructing derived characteristics of the travel traffic volume, and constructing a multivariable linear regression model based on historical travel traffic volume characteristics; correcting the predicted travel traffic volume obtained by the multivariable linear regression model; correcting the predicted travel traffic volume of the remaining dates of holidays; constructing a travel traffic volume model of a stratified flow road network; and constructing an objective function, and optimizing and solving the travel traffic volume model of the stratified flow road network to obtain a predicted result of the holiday expressway travel traffic volume.

### TECHNICAL FIELD

The present application belongs to the technical field of road traffic flow prediction, and in particular relates to a method of predicting a holiday expressway travel traffic volume based on influence of weather factors.

### BACKGROUND

As the coverage of expressways continues to increase and the expressway network toll collection system is gradually improved, expressways play a very important role in the transportation system. Especially during holidays, people's demand for medium- and long-distance travel increases, and expressways play a major role in inter-city and inter-provincial travel.

In order to meet the demand of releasing and controlling information of holiday travel peaks, expressway regulatory authorities need to predict the holiday travel information in advance about one week before the holiday, reminding travelers of daily changes in the total travel volume, congested road sections and time periods. Therefore, it is necessary to predict the holiday travel Origin-Destination (OD) in advance. However, at present, there are mainly two types of research on expressway traffic volume prediction, one of which is short-term prediction, and the other of which is traffic volume prediction for medium- and long-term planning and construction. The medium- and long-term prediction usually carries out trend analysis and prediction in conjunction with the growth trend of previous years or carries out regression analysis and prediction in conjunction with macro-development indicators (such as the number of vehicles, gross regional domestic products, regional registered population, etc.) based on the holiday travel rules of previous years. The above methods can only obtain the total travel volume in a macroscopic scale, and the prediction granularity is coarse, which is not enough to support the demand of releasing and finely controlling information of holiday travel.

The short-term prediction needs real-time detection data as input, which cannot meet the application demand of releasing early warning information and making control measures in advance. There is little research on expressway prediction scenarios one week in advance. Moreover, due to the long interval between holidays, the current road network and traffic operation state may have changed significantly compared with those of the holidays in the same period last year due to factors such as the addition of new stations, the increased travel demand, and weather. In addition, the diversity of weather has led to a small number of historical sample data, so that it is difficult to predict the traffic volume and the OD allocation.

### SUMMARY

In order to accurately predict a holiday expressway travel volume based on influence of weather factors, the present application puts forward a method of predicting a holiday expressway travel traffic volume based on influence of weather factors.

In order to achieve the above purpose, the present application is implemented by the following technical scheme.

A method of predicting a holiday expressway travel traffic volume based on influence of weather factors is provided, including the following steps:
S1, collecting historical weather data and historical holiday travel traffic volume data, and establishing a relative influence coefficient between historical weather and a travel traffic volume;
S2, constructing, based on the relative influence coefficient between the historical weather and the travel traffic volume obtained in Step S1, a travel traffic volume transfer model based on weather data;
S3, analyzing, based on the historical holiday travel traffic volume data obtained in Step S1, the daily travel traffic volume of a plurality of historical similar holidays, selecting basic characteristics of the travel traffic volume, constructing derived characteristics of the travel traffic volume through crossover operation between the basic characteristics of the travel traffic volume, and then constructing a multivariable linear regression model based on historical travel traffic volume characteristics; and correcting the predicted travel traffic volume obtained by the multivariable linear regression model based on the travel traffic volume transfer model constructed in Step S2;
S4, correcting, after collecting the actual travel traffic volume data of the previous day during holidays, the predicted travel traffic volume of the remaining dates of holidays by comparing the actual travel traffic volume with a travel traffic volume of a corresponding date predicted based on Step S3 to obtain the corrected predicted travel traffic volume of the remaining dates of holidays;
S5, obtaining, based on the methods of Step S2, Step S3 and Step S4, a departure volume of each starting point and an arrival volume of each ending point predicted for each day of holidays, and constructing a travel traffic volume model of a stratified flow road network based on a time allocation ratio of historical characteristic dates; and
S6, constructing an objective function, and optimizing and solving the travel traffic volume model of the stratified flow road network obtained in Step S5 by using a reverse gradient propagation method to obtain a predicted result of the holiday expressway travel traffic volume based on influence of weather factors.

Further, the specific implementation method of Step S1 includes the following steps:
S1.1, collecting historical weather data, where the historical weather data includes dates, regions and weather types, and collecting historical holiday travel traffic volume information data, where the historical holiday travel traffic volume information data includes dates, toll stations, traffic and regions to which the toll stations belong; and
S1.2, establishing a relative influence coefficient wₐ between historical weather and a travel traffic volume, the calculation expression being:

$${w}_{a} = ( \frac{1}{{n}_{a}} {\sum }_{i ∈ {D}_{a}} {y}_{i} ) / ( \frac{1}{{n}_{b}} {\sum }_{i ∈ {D}_{b}} {y}_{i} )$$

where Dₐ is a sample date corresponding to a weather type a, nₐ is the number of sample days corresponding to the weather type a, yᵢ is the travel traffic volume on the i^{th} day, D_{b} is a sample date corresponding to a weather type b, n_{b} is the number of sample days corresponding to the weather type b, the travel traffic volume of the weather type b is selected as a benchmark, and the relative influence coefficient wₐ between the historical weather and the travel traffic volume is calibrated.

Further, subsequent to Step S2 and prior to Step S3, defining, by the travel traffic volume transfer model based on weather data a travel volume reduced due to weather influence as a travel outflow volume, and a travel volume increased due to weather influence as a travel inflow volume, where the calculation expression of calculating the total travel traffic volume according to a weather influence coefficient is:

$${y}_{i}^{′} = \{ \begin{matrix}{y}_{i} / {w}_{a} , i ∈ a \\ {y}_{i} - {\sum }_{j ∈ a} ( {y}_{j}^{′} - {y}_{j} ) \times \frac{{y}_{i}}{{\sum }_{i ∈ b} {y}_{i}}\end{matrix} , i ∈ b .$$

Further, the specific implementation method of Step S3 includes the following steps:
S3.1, analyzing the daily travel traffic volume of a plurality of historical similar holidays, and selecting basic characteristics of the travel traffic volume, where the basic characteristics of the travel traffic volume include the characteristics of the travel traffic volume of the same historical holidays after being corrected by a travel time transfer model, the characteristics of the average travel traffic volume in a week before the same historical holidays, the characteristics of the predicted average travel traffic volume in a week before the holidays and the characteristics of the predicted average travel traffic volume in a normal week of the holidays;
S3.2, constructing derived characteristics of the travel traffic volume using crossover operation through the four basic characteristics of the travel traffic volume selected in Step S3.1, which are denoted as Xᵢ={xᵢ₁, xᵢ₂, . . . , xᵢₘ}, where xᵢₘ is the m^{th} associated characteristic of the travel traffic volume on the 7th day;
S3.3, using a Pearson correlation coefficient to analyze a correlation between a variable of the derived characteristics of the travel traffic volume Xⱼ={x₁ⱼ, x₂ⱼ, . . . , xₙⱼ} and a variable of the predicted travel traffic volume Y={y₁, y₂, . . . , yₙ} based on n holiday samples, and keeping the first k important characteristics of a correlation coefficient P(Xⱼ, Y)>δ, where the calculation expression of the Pearson correlation coefficient is:

$$ρ ( {X}_{j} , Y ) = \frac{E [ ( {X}_{j} - {μ}_{{X}_{j}} ) ( Y - {μ}_{Y} ) ]}{{σ}_{{X}_{j}} {σ}_{Y}} = \frac{E [ ( {X}_{j} - {μ}_{{X}_{j}} ) ( Y - {μ}_{Y} ) ]}{\sqrt{E [ {( {X}_{j} - {μ}_{{X}_{j}} )}^{2} ] E [ {( Y - {μ}_{Y} )}^{2} ]}}$$

where ρ(Xⱼ, Y) is a correlation coefficient, E denotes a mean value, μ_{X}_{ⱼ}, μ_{Y} are mean values of Xⱼ and Y, respectively, σ_{X}_{ⱼ}, σ_{Y} are variances of Xⱼ and Y, respectively, and δ is a set correlation coefficient threshold which is configured to screen important characteristics;
repeating the characteristic crossover and correlation screening process, and keeping a set of important derived characteristics of the travel traffic volume X={Xⱼ:j=1, 2, . . . , k}, where k is the total number of the important derived characteristics of the travel traffic volume;
S3.4, establishing a multivariable linear regression model based on historical travel traffic volume characteristics, where the important derived characteristics of the travel traffic volume and the variable of the predicted travel traffic volume have a matrix form of Y=AX, where A is an undetermined coefficient matrix of the multivariable linear regression equation, and αₖ is an undetermined coefficient of the k^{th} multivariable linear regression equation, the expression being:

$$Y = [ \begin{matrix}{y}_{1} \\ {y}_{2} \\ ⋮ \\ {y}_{n}\end{matrix} ] , X = [ \begin{matrix}1 & {x}_{11} & {x}_{12} & … & {x}_{1 k} \\ 1 & {x}_{21} & {x}_{22} & … & {x}_{2 k} \\ ⋮ & ⋮ & ⋮ & ⋱ & ⋮ \\ 1 & {x}_{n 1} & {x}_{n 2} & … & {x}_{nk}\end{matrix} ] , A = [ \begin{matrix}{α}_{0} \\ {α}_{1} \\ ⋮ \\ {α}_{k}\end{matrix} ] ; and$$

S3.5, setting ŷᵢ as a predicted travel traffic volume without considering weather factors, first, correcting the predicted travel traffic volume of the weather type a based on the weather influence coefficient to obtain the travel outflow volume at the same time, and then allocating the travel inflow volume according to the predicted travel traffic volume of the weather type b proportionally, so as to update the predicted travel traffic volume ŷ′ᵢ based on influence of weather factors, the calculation expression being:

$${\hat{y}}_{i}^{′} = \{ \begin{matrix}{\hat{y}}_{i} \times {w}_{a} , i ∈ a \\ {\hat{y}}_{i} + {\sum }_{j ∈ a} ( {\hat{y}}_{i} - {\hat{y}}_{j}^{′} ) \times \frac{{\hat{y}}_{i}}{{\sum }_{i ∈ b} {\hat{y}}_{i}}\end{matrix} , i ∈ b .$$

Further, the specific implementation method of Step S4 includes the following steps:
S4.1, assuming that there are s₁+s₂ days of holidays, collecting an actual travel traffic volume of the first s₁ days of holidays as {yᵢ₋ₛ_{₁}, . . . , yᵢ₋₁} and a predicted travel traffic volume of the first s₁ days of holidays obtained by using Step S3 as {ŷ′ᵢ₋ₛ_{₁}, . . . , ŷ′ᵢ₋₁};
S4.2, constructing a correction coefficient γ of the predicted travel traffic volume of holidays, the calculation expression being:

$$γ = \frac{1}{{s}_{1}} {\sum }_{j = 1}^{{S}_{1}} ( \frac{{y}_{i - j}}{{\hat{y}}_{i - j}^{′}} ) ;$$

and
S4.3, updating a predicted travel traffic volume of the remaining s₂ days of holidays by using the correction coefficient of the predicted travel traffic volume of holidays obtained in Step S4.2, so as to obtain a corrected predicted travel traffic volume of the remaining dates of holidays {γ·ŷ′ᵢ, . . . , γ·ŷᵢ₊ₛ₂}.

Further, the specific implementation method of Step S5 includes the following steps:
S5.1, obtaining, based on the methods of Step S2, Step S3 and Step S4, a departure volume yₒ of each starting point and an arrival volume yᵤ of each ending point predicted for each day of holidays, and based on a time allocation ratio W₀ of historical characteristic dates, obtaining a departure volume o(t)=W₀(t)yᵤ at each time t, t=1, . . . , T, which is denoted as matrix O∈R_{1×T}, where T is a time matrix, and O is a departure volume matrix,
and an arrival volume u(t)=W₀(t)yᵤ at each time t, t=1, . . . , T, which is denoted as matrix U∈R_{1×T}, where U is an arrival volume matrix; and
S5.2, constructing a travel traffic volume model of a stratified flow road network, including a departure station layer, an Origin-Destination (OD) layer, a path layer, a travel time layer and an arrival station layer:
S5.2.1, the departure station layer: taking the departure station layer as the departure volume matrix O∈R_{1×T};
S5.2.2, the OD layer: setting the number of stations in the road network as N, calculating the allocation ratio from each starting point to different ending points based on historical OD data, which is denoted as W₁, and obtaining a predicted travel traffic volume Z=W₁O, Z∈R_{1×T×N} according to the allocation ratio;
S5.2.3, the path layer: screening, based on historical individual travel path data, the first M paths with the largest number of travels between each pair of ODs and their allocation ratio, which is denoted as W₂, obtaining predicted path traffic P=W₂Z, P∈R_{1×T×N×M} according to the allocation ratio, denoting pⱼ(t) as path traffic of path j at time t, j=1, . . . , N× M; t=1, . . . , T;
S5.2.4, the travel time layer: calculating, based on the historical individual travel data, travel time of each path, H={hⱼ(t), j=1, . . . , N×M; t=1, . . . , T}, and obtaining traffic of arriving at the ending point through the path j from time t, G={gⱼ(t)=pⱼ(t+hⱼ(t)), j=1, . . . , N×M; t=1, . . . , T}, G∈R_{1×T×N×M},
S5.2.5, the arrival station layer: aggregating the arrival traffic according to time to obtain arrival traffic û(t)=Σⱼ₌₁^{N×M}gⱼ(t) of each station at each time, which is denoted as the matrix Û∈R_{1×T}.

Further, the specific implementation method of Step S6 includes the following steps:
S6.1, constructing an objective function, the calculation expression being:

$$min {\sum }_{t = 1}^{T} ( \hat{u} ( t ) - u ( t ) ) ;$$

and
S6.2, optimizing and solving the objective function constructed in Step S6.1 by using a reverse gradient propagation method, and adjusting the allocation ratios W₁ and W₂ to obtain the optimized travel traffic volume Z.

The present application has the following beneficial effects.

The method of predicting a holiday expressway travel traffic volume based on influence of weather factors according to the present application is suitable for short- and medium-term prediction scenarios of holidays of expressways based on influence of weather.

The method of predicting a holiday expressway travel traffic volume based on influence of weather factors according to the present application has been experimentally verified to have a prediction accuracy of 90% (MAPE) for the total daily travel volume during holidays and a prediction accuracy of R2=94% for the inflow volume and the outflow volume of stations.

The method of predicting a holiday expressway travel traffic volume based on influence of weather factors according to the present application can implement multi-layer prediction of the departure volume, the arrival volume and the OD volume of expressway stations, provide multi-dimensional holiday travel state prediction, support further road operation state analysis during holidays, and support the application of releasing and controlling early warning information of holidays in expressway systems.

### BRIEF DESCRIPTION OF DRAWINGS

FIG. 1 is a schematic flow chart of a method of predicting a holiday expressway travel traffic volume based on influence of weather factors according to the present application.

FIG. 2 is a schematic structural diagram of an OD travel traffic volume model of a stratified flow road network of a method of predicting a holiday expressway travel traffic volume based on influence of weather factors according to the present application.

### DETAILED DESCRIPTION

In order to make the purposes, technical schemes and advantages of the present application clearer, the present application will be further described in detail with reference to the accompanying drawings and specific embodiments. It should be understood that the specific embodiments described herein are only used to explain the present application, rather than limit the present application. That is, the described specific embodiments are only some specific embodiments, rather than all specific embodiments of the present application. The components in the specific embodiments of the present application, which are generally described and shown in the accompanying drawings herein, can be arranged and designed in various different configurations. The present application can also have other embodiments.

Therefore, the following detailed description of the specific embodiments of the present application provided in the accompanying drawings is not intended to limit the claimed scope of the present application, but is only intended to represent the selected specific embodiments of the present application. All other specific embodiments obtained by those skilled in the art without creative work based on the specific embodiments of the present application belong to the scope of protection of the present application.

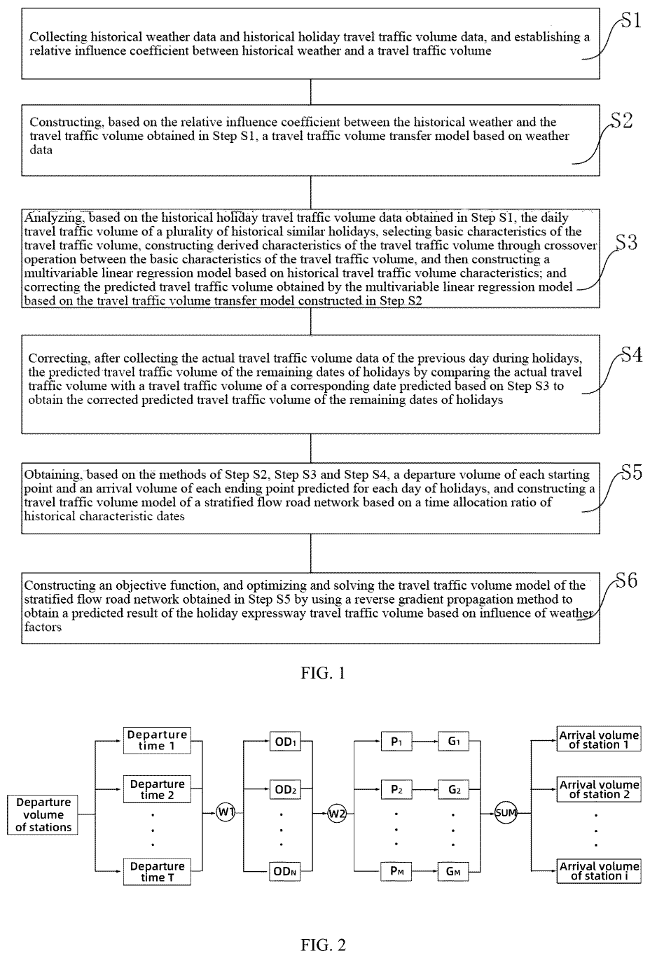

In order to further understand the application contents, characteristics and effects of the present application, the following specific embodiments are exemplified and described in detail with reference to FIG. 1 and FIG. 2.

### SPECIFIC EMBODIMENT ONE

Refer to FIG. 1, which is a schematic flow chart of a method of predicting a holiday expressway travel traffic volume based on influence of weather factors. The method of predicting a holiday expressway travel traffic volume based on influence of weather factors may include the following steps.

In S1, historical weather data and historical holiday travel traffic volume data are collected, and a relative influence coefficient between historical weather and a travel traffic volume is established.

Further, the specific implementation method of Step S1 includes the following steps:
S1.1, collecting historical weather data, where the historical weather data includes dates, regions and weather types, and collecting historical holiday travel traffic volume information data, where the historical holiday travel traffic volume information data includes dates, toll stations, traffic and regions to which the toll stations belong; and
S1.2, establishing a relative influence coefficient wₐ between historical weather and a travel traffic volume, the calculation expression being:

$${w}_{a} = ( \frac{1}{{n}_{a}} {\sum }_{i ∈ {D}_{a}} {y}_{i} ) / ( \frac{1}{{n}_{b}} {\sum }_{i ∈ {D}_{b}} {y}_{i} )$$

where Dₐ is a sample date corresponding to a weather type a, nₐ is the number of sample days corresponding to the weather type a, yᵢ is the travel traffic volume on the i^{th} day, D_{b} is a sample date corresponding to a weather type b, n_{b} is the number of sample days corresponding to the weather type b, the travel traffic volume of the weather type b is selected as a benchmark, and the relative influence coefficient wₐ between the historical weather and the travel traffic volume is calibrated.

In S2, based on the relative influence coefficient between the historical weather and the travel traffic volume obtained in Step S1, a travel traffic volume transfer model based on weather data is constructed.

Further, subsequent to Step S2 and prior to Step S3, the travel traffic volume transfer model based on weather data defines a travel volume reduced due to weather influence as a travel outflow volume, and a travel volume increased due to weather influence as a travel inflow volume, where the calculation expression of calculating the total travel traffic volume according to a weather influence coefficient is:

$${y}_{i}^{′} = \{ \begin{matrix}{y}_{i} / {w}_{a} , i ∈ a \\ {y}_{i} - {\sum }_{j ∈ a} ( {y}_{j}^{′} - {y}_{j} ) \times \frac{{y}_{i}}{{\sum }_{i ∈ b} {y}_{i}} , i ∈ b .\end{matrix}$$

In S3, based on the historical holiday travel traffic volume data obtained in Step S1, the daily travel traffic volume of a plurality of historical similar holidays is analyzed, basic characteristics of the travel traffic volume are selected, derived characteristics of the travel traffic volume are constructed through crossover operation between the basic characteristics of the travel traffic volume, and then a multivariable linear regression model based on historical travel traffic volume characteristics is constructed; and the predicted travel traffic volume obtained by the multivariable linear regression model is corrected based on the travel traffic volume transfer model constructed in Step S2.

Further, the specific implementation method of Step S3 includes the following steps:
S3.1, analyzing the daily travel traffic volume of a plurality of historical similar holidays, and selecting basic characteristics of the travel traffic volume, where the basic characteristics of the travel traffic volume include the characteristics of the travel traffic volume of the same historical holidays after being corrected by a travel time transfer model, the characteristics of the average travel traffic volume in a week before the same historical holidays, the characteristics of the predicted average travel traffic volume in a week before the holidays and the characteristics of the predicted average travel traffic volume in a normal week of the holidays;
S3.2, constructing derived characteristics of the travel traffic volume using crossover operation through the four basic characteristics of the travel traffic volume selected in Step S3.1, which are denoted as Xᵢ={xᵢ₁, xᵢ₂, . . . , xᵢₘ}, where xᵢₘ is the m^{th} associated characteristic of the travel traffic volume on the i^{th} day;
S3.3, using a Pearson correlation coefficient to analyze a correlation between a variable of the derived characteristics of the travel traffic volume Xⱼ={x₁ⱼ, x₂ⱼ, . . . , xₙⱼ} and a variable of the predicted travel traffic volume Y={y₁, y₂, . . . , yₙ} based on n holiday samples, and keeping the first k important characteristics of a correlation coefficient p(Xⱼ,Y)>δ, where the calculation expression of the Pearson correlation coefficient is:

$$ρ ( {X}_{j} , Y ) = \frac{E [ ( {X}_{j} - {μ}_{{X}_{j}} ) ( Y - {μ}_{Y} ) ]}{{σ}_{{X}_{j}} {σ}_{Y}} = \frac{E [ ( {X}_{j} - {μ}_{{X}_{j}} ) ( Y - {μ}_{Y} ) ]}{\sqrt{E [ {( {X}_{j} - {μ}_{{X}_{j}} )}^{2} ] E [ {( Y - {μ}_{Y} )}^{2} ]}}$$

where ρ(Xⱼ,Y) is a correlation coefficient, E denotes a mean value, μ_{X}_{ⱼ}, μ_{Y} are mean values of Xⱼ and Y, respectively, σ_{X}_{ⱼ}, σ_{Y} are variances of Xⱼ and Y, respectively, and δ is a set correlation coefficient threshold which is configured to screen important characteristics;
repeating the characteristic crossover and correlation screening process, and keeping a set of important derived characteristics of the travel traffic volume X={Xⱼ: j=1, 2, . . . , k}, where k is the total number of the important derived characteristics of the travel traffic volume;
S3.4, establishing a multivariable linear regression model based on historical travel traffic volume characteristics, where the important derived characteristics of the travel traffic volume and the variable of the predicted travel traffic volume have a matrix form of Y=AX, where A is an undetermined coefficient matrix of the multivariable linear regression equation, and αₖ is an undetermined coefficient of the k^{th} multivariable linear regression equation, the expression being:

$$Y = [ \begin{matrix}{y}_{1} \\ {y}_{2} \\ ⋮ \\ {y}_{n}\end{matrix} ] , X = [ \begin{matrix}1 & {x}_{11} & {x}_{12} & … & {x}_{1 k} \\ 1 & {x}_{21} & {x}_{22} & … & {x}_{2 k} \\ ⋮ & ⋮ & ⋮ & ⋱ & ⋮ \\ 1 & {x}_{n 1} & {x}_{n 2} & … & {x}_{nk}\end{matrix} ] , A = [ \begin{matrix}{α}_{0} \\ {α}_{1} \\ ⋮ \\ {α}_{k}\end{matrix} ] ;$$

and
S3.5, setting ŷᵢ as a predicted travel traffic volume without considering weather factors, first, correcting the predicted travel traffic volume of the weather type a based on the weather influence coefficient to obtain the travel outflow volume at the same time, and then allocating the travel inflow volume according to the predicted travel traffic volume of the weather type b proportionally, so as to update the predicted travel traffic volume ŷ′ᵢ based on influence of weather factors, the calculation expression being:

$${\hat{y}}_{i}^{′} = \{ \begin{matrix}{\hat{y}}_{i} \times {w}_{a} , i ∈ a \\ {\hat{y}}_{i} + {\sum }_{j ∈ a} ( {\hat{y}}_{i} - {\hat{y}}_{j}^{′} ) \times \frac{{\hat{y}}_{i}}{{\sum }_{i ∈ b} {\hat{y}}_{i}} , i ∈ b\end{matrix} .$$

In S4, after collecting the actual travel traffic volume data of the previous day during holidays, the predicted travel traffic volume of the remaining dates of holidays is corrected by comparing the actual travel traffic volume with a travel traffic volume of a corresponding date predicted based on Step S3 to obtain the corrected predicted travel traffic volume of the remaining dates of holidays.

Further, the specific implementation method of Step S4 includes the following steps:
S4.1, assuming that there are s₁+s₂ days of holidays, collecting an actual travel traffic volume of the first s₁ days of holidays as {yᵢ₋ₛ_{₁}, . . . , yᵢ₋₁} and a predicted travel traffic volume of the first s₁ days of holidays obtained by using Step S3 as {ŷ′ᵢ₋ₛ_{₁}, . . . , ŷ′ᵢ₋₁};
S4.2, constructing a correction coefficient γ of the predicted travel traffic volume of holidays, the calculation expression being:

$$γ = \frac{1}{{s}_{1}} {\sum }_{j = 1}^{{s}_{1}} ( \frac{{y}_{i - j}}{{\hat{y}}_{i - j}^{′}} ) ;$$

S4.3, updating a predicted travel traffic volume of the remaining s₂ days of holidays by using the correction coefficient of the predicted travel traffic volume of holidays obtained in Step S4.2, so as to obtain a corrected predicted travel traffic volume of the remaining dates of holidays {γ·ŷ′ᵢ, . . . , γ·ŷ′ᵢ₊ₛ₂}.

In S5, based on the methods of Step S2, Step S3 and Step S4, a departure volume of each starting point and an arrival volume of each ending point predicted for each day of holidays are obtained, and a travel traffic volume model of a stratified flow road network is constructed based on a time allocation ratio of historical characteristic dates.

Refer to FIG. 2, which is a schematic structural diagram of an OD travel traffic volume model of a stratified flow road network of a method of predicting a holiday expressway travel traffic volume based on influence of weather factors.

Further, the specific implementation method of Step S5 includes the following steps:
S5.1, obtaining, based on the methods of Step S2, Step S3 and Step S4, a departure volume yₒ of each starting point and an arrival volume yᵤ of each ending point predicted for each day of holidays, and based on a time allocation ratio W₀ of historical characteristic dates, obtaining a departure volume o(t)=W₀(t)yₒ at each time t, t=1, . . . , T, which is denoted as matrix O∈R_{1×T}, where T is a time matrix, and O is a departure volume matrix,
and an arrival volume u (t)=W₀(t)yᵤ at each time t, t=1, . . . , T, which is denoted as matrix U∈R_{1×T}, where U is an arrival volume matrix; and
S5.2, constructing a travel traffic volume model of a stratified flow road network, including a departure station layer, an Origin-Destination (OD) layer, a path layer, a travel time layer and an arrival station layer:
S5.2.1, the departure station layer: taking the departure station layer as the departure volume matrix O∈R_{1×T};
S5.2.2, the OD layer: setting the number of stations in the road network as N, calculating the allocation ratio from each starting point to different ending points based on historical OD data, which is denoted as W₁, and obtaining a predicted travel traffic volume Z=W₁O, Z∈R_{1×T×N} according to the allocation ratio;
S5.2.3, the path layer: screening, based on historical individual travel path data, the first M paths with the largest number of travels between each pair of ODs and their allocation ratio, which is denoted as W₂, obtaining predicted path traffic P=W₂Z, P∈R_{1×T×N×M} according to the allocation ratio, denoting pⱼ(t) as path traffic of path j at time t, j=1, . . . , N×M; t=1, . . . , T;
S5.2.4, the travel time layer: calculating, based on the historical individual travel data, travel time of each path, H={hⱼ(t), j=1, . . . , N×M; t=1, . . . , T}, and obtaining traffic of arriving at the ending point through the path j from time t, G={gⱼ(t)=pⱼ(t+hⱼ(t)), j=1, . . . , N×M; t=1, . . . , T}, G∈R_{1×T×N×M};
S5.2.5, the arrival station layer: aggregating the arrival traffic according to time to obtain arrival traffic û(t)=Σⱼ₌₁^{N×M}gⱼ(t) of each station at each time, which is denoted as the matrix Û∈R_{1×T}.

In S6, an objective function is constructed, and the travel traffic volume model of the stratified flow road network obtained in Step S5 is optimized and solved by using a reverse gradient propagation method to obtain a predicted result of the holiday expressway travel traffic volume based on influence of weather factors.

Further, the specific implementation method of Step S6 includes the following steps:
S6.1, constructing an objective function, the calculation expression being:

$$min {\sum }_{t = 1}^{T} ( \hat{u} ( t ) - u ( t ) ) ;$$

and
S6.2, optimizing and solving the objective function constructed in Step S6.1 by using a reverse gradient propagation method, and adjusting the allocation ratios W₁ and W₂ to obtain the optimized travel traffic volume Z.

It should be noted that the relational terms such as “first”, “second” and the like herein are only used to distinguish one entity or operation from another entity or operation, and do not necessarily require or imply that there is any such actual relationship or order between these entities or operations. Moreover, the terms “including”, “comprising” or any other variation thereof are intended to cover a non-exclusive inclusion, so that a process, method, article or device including a series of elements includes not only those elements but also other elements not explicitly listed, or elements inherent to such process, method, article or device. In the absence of more restrictions, an element defined by the phrase “including one” does not exclude the presence of other identical elements in the process, method, article or device including the element.

Although the present application has been described above with reference to the specific embodiments, various improvements can be made and components therein can be replaced with equivalents without departing from the scope of the present application. In particular, as long as there is no structural conflict, all the characteristics in the specific embodiments disclosed in the present application can be combined with each other in any way for use. These combinations are not exhaustively described in the specification only for the sake of omitting space and saving resources. Therefore, the present application is not limited to the specific embodiments disclosed herein, but includes all technical schemes falling within the scope of the claims.

What is claimed is:

1. A method of predicting a holiday expressway travel traffic volume based on influence of weather factors, comprising the following steps:
S1, collecting historical weather data and historical holiday travel traffic volume data, and establishing a relative influence coefficient between historical weather and a travel traffic volume;
S2, constructing, based on the relative influence coefficient between the historical weather and the travel traffic volume obtained in Step S1, a travel traffic volume transfer model based on weather data;
S3, analyzing, based on the historical holiday travel traffic volume data obtained in Step S1, the daily travel traffic volume of a plurality of historical similar holidays, selecting basic characteristics of the travel traffic volume, constructing derived characteristics of the travel traffic volume through crossover operation between the basic characteristics of the travel traffic volume, and then constructing a multivariable linear regression model based on historical travel traffic volume characteristics; and correcting the predicted travel traffic volume obtained by the multivariable linear regression model based on the travel traffic volume transfer model constructed in Step S2;
S4, correcting, after collecting the actual travel traffic volume data of the previous day during holidays, the predicted travel traffic volume of the remaining dates of holidays by comparing the actual travel traffic volume with a travel traffic volume of a corresponding date predicted based on Step S3 to obtain the corrected predicted travel traffic volume of the remaining dates of holidays;
S5, obtaining, based on the methods of Step S2, Step S3 and Step S4, a departure volume of each starting point and an arrival volume of each ending point predicted for each day of holidays, and constructing a travel traffic volume model of a stratified flow road network based on a time allocation ratio of historical characteristic dates; and
S6, constructing an objective function, and optimizing and solving the travel traffic volume model of the stratified flow road network obtained in Step S5 by using a reverse gradient propagation method to obtain a predicted result of the holiday expressway travel traffic volume based on influence of weather factors.

2. The method of predicting a holiday expressway travel traffic volume based on influence of weather factors according to claim 1, wherein the specific implementation method of Step S1 comprises the following steps:
S1.1, collecting historical weather data, wherein the historical weather data comprises dates, regions and weather types, and collecting historical holiday travel traffic volume information data, wherein the historical holiday travel traffic volume information data comprises dates, toll stations, traffic and regions to which the toll stations belong; and
S1.2, establishing a relative influence coefficient wₐ between historical weather and a travel traffic volume, the calculation expression being:
$${w}_{a} = ( \frac{1}{{n}_{a}} {\sum }_{i ∈ {D}_{a}} {y}_{i} ) / ( \frac{1}{{n}_{b}} {\sum }_{i ∈ {D}_{b}} {y}_{i} )$$
where Dₐ is a sample date corresponding to a weather type a, nₐ is the number of sample days corresponding to the weather type a, yᵢ is the travel traffic volume on the i^{th} day, D_{b} is a sample date corresponding to a weather type b, n_{b} is the number of sample days corresponding to the weather type b, the travel traffic volume of the weather type b is selected as a benchmark, and the relative influence coefficient wₐ between the historical weather and the travel traffic volume is calibrated.

3. The method of predicting a holiday expressway travel traffic volume based on influence of weather factors according to claim 1, wherein subsequent to Step S2 and prior to Step S3, the method further comprises:
defining, by the travel traffic volume transfer model based on weather data, a travel volume reduced due to weather influence as a travel outflow volume, and a travel volume increased due to weather influence as a travel inflow volume, wherein the calculation expression of calculating the total travel traffic volume according to a weather influence coefficient is:
$${y}_{i}^{′} = \{ \begin{matrix}{y}_{i} \times {w}_{a} , i ∈ a \\ {y}_{i} + {\sum }_{j ∈ a} ( {y}_{i}^{′} - {y}_{j} ) \times \frac{{y}_{i}}{{\sum }_{i ∈ b} {y}_{i}} , i ∈ b\end{matrix} .$$

4. The method of predicting a holiday expressway travel traffic volume based on influence of weather factors according to claim 1, wherein the specific implementation method of Step S3 comprises the following steps:
S3.1, analyzing the daily travel traffic volume of a plurality of historical similar holidays, and selecting basic characteristics of the travel traffic volume, wherein the basic characteristics of the travel traffic volume comprise the characteristics of the travel traffic volume of the same historical holidays after being corrected by a travel time transfer model, the characteristics of the average travel traffic volume in a week before the same historical holidays, the characteristics of the predicted average travel traffic volume in a week before the holidays and the characteristics of the predicted average travel traffic volume in a normal week of the holidays;
S3.2, constructing derived characteristics of the travel traffic volume using crossover operation through the four basic characteristics of the travel traffic volume selected in Step S3.1, which are denoted as Xᵢ={xᵢ₁, xᵢ₂, . . . , xᵢₘ}, where xᵢₘ is the m^{th} associated characteristic of the travel traffic volume on the i^{th} day;
S3.3, using a Pearson correlation coefficient to analyze a correlation between a variable of the derived characteristics of the travel traffic volume Xⱼ={x₁ⱼ, x₂ⱼ, . . . , xₙⱼ} and a variable of the predicted travel traffic volume Y={y₁, y₂, . . . , yₙ} based on n holiday samples, and keeping the first k important characteristics of a correlation coefficient ρ(Xⱼ,Y)>δ, wherein the calculation expression of the Pearson correlation coefficient is:
$$ρ ( {X}_{j} , Y ) = \frac{E [ ( {X}_{j} - {μ}_{{X}_{j}} ) ( Y - {μ}_{Y} ) ]}{{σ}_{{X}_{j}} {σ}_{Y}} = \frac{E [ ( {X}_{j} - {μ}_{{X}_{j}} ) ( Y - {μ}_{Y} ) ]}{\sqrt{E [ {( {X}_{j} - {μ}_{{X}_{j}} )}^{2} ] E [ {( Y - {μ}_{Y} )}^{2} ]}}$$
where ρ(Xⱼ,Y) is a correlation coefficient, E denotes a mean value, μ_{X}_{ⱼ}, μ_{Y} are mean values of Xⱼ and Y, respectively, σ_{X}_{ⱼ}, σ_{Y} are variances of Xⱼ and Y, respectively, and δ is a set correlation coefficient threshold which is configured to screen important characteristics;
repeating the characteristic crossover and correlation screening process, and keeping a set of important derived characteristics of the travel traffic volume X={Xⱼ: j=1, 2, . . . , k}, where k is the total number of the important derived characteristics of the travel traffic volume;
S3.4, establishing a multivariable linear regression model based on historical travel traffic volume characteristics, wherein the important derived characteristics of the travel traffic volume and the variable of the predicted travel traffic volume have a matrix form of Y=AX, where A is an undetermined coefficient matrix of the multivariable linear regression equation, and αₖ is an undetermined coefficient of the k^{th} multivariable linear regression equation, the expression being:
$$Y = [ \begin{matrix}{y}_{1} \\ {y}_{2} \\ ⋮ \\ {y}_{n}\end{matrix} ] , X = [ \begin{matrix}1 & {x}_{11} & {x}_{12} & … & {x}_{1 k} \\ 1 & {x}_{21} & {x}_{22} & … & {x}_{2 k} \\ ⋮ & ⋮ & ⋮ & ⋱ & ⋮ \\ 1 & {x}_{n 1} & {x}_{n 2} & … & {x}_{nk}\end{matrix} ] , A = [ \begin{matrix}{α}_{0} \\ {α}_{1} \\ ⋮ \\ {α}_{k}\end{matrix} ] ;$$
and
S3.5, setting ŷᵢ as a predicted travel traffic volume without considering weather factors, first, correcting the predicted travel traffic volume of the weather type a based on the weather influence coefficient to obtain the travel outflow volume at the same time, and then allocating the travel inflow volume according to the predicted travel traffic volume of the weather type b proportionally, so as to update the predicted travel traffic volume ŷ′ᵢ based on influence of weather factors, the calculation expression being:
$${\hat{y}}_{i}^{′} = \{ \begin{matrix}{\hat{y}}_{i} \times {w}_{a} , i ∈ a \\ {\hat{y}}_{i} + {\sum }_{j ∈ a} ( {\hat{y}}_{i} - {\hat{y}}_{j}^{′} ) \times \frac{{\hat{y}}_{i}}{{\sum }_{i ∈ b} {\hat{y}}_{i}} , i ∈ b\end{matrix} .$$

5. The method of predicting a holiday expressway travel traffic volume based on influence of weather factors according to claim 1, wherein the specific implementation method of Step S4 comprises the following steps:
S4.1, assuming that there are s₁+s₂ days of holidays, collecting an actual travel traffic volume of the first s₁ days of holidays as {yᵢ₋ₛ_{₁}_{′}. . . , yᵢ₋₁} and a predicted travel traffic volume of the first s₁ days of holidays obtained by using Step S3 as {ŷ′ᵢ₋ₛ_{₁}_{′}, . . . , ŷ′ᵢ₋₁};
S4.2, constructing a correction coefficient γ of the predicted travel traffic volume of holidays, the calculation expression being:
$$γ = \frac{1}{{s}_{1}} {\sum }_{j = 1}^{{s}_{1}} ( \frac{{y}_{i - j}}{{\hat{y}}_{i - j}^{′}} ) ;$$
and
S4.3, updating a predicted travel traffic volume of the remaining s₂ days of holidays by using the correction coefficient of the predicted travel traffic volume of holidays obtained in Step S4.2, so as to obtain a corrected predicted travel traffic volume of the remaining dates of holidays {γ·ŷ′ᵢ, . . . , γ·ŷᵢ₊ₛ₂}.

6. The method of predicting a holiday expressway travel traffic volume based on influence of weather factors according to claim 1, wherein the specific implementation method of Step S5 comprises the following steps:
S5.1, obtaining, based on the methods of Step S2, Step S3 and Step S4, a departure volume yₒ of each starting point and an arrival volume yᵤ of each ending point predicted for each day of holidays, and based on a time allocation ratio W₀ of historical characteristic dates, obtaining a departure volume o(t)=W₀(t)yₒ at each time t, t=1, . . . , T, which is denoted as matrix O∈R_{1×T}, where T is a time matrix, and O is a departure volume matrix,
and an arrival volume u(t)=W₀(t)yᵤ at each time t, t=1, . . . , T, which is denoted as matrix U∈R_{1×T}, where U is an arrival volume matrix; and
S5.2, constructing a travel traffic volume model of a stratified flow road network, comprising a departure station layer, an Origin-Destination (OD) layer, a path layer, a travel time layer and an arrival station layer:
S5.2.1, the departure station layer: taking the departure station layer as the departure volume matrix O∈R_{1×T};
S5.2.2, the OD layer: setting the number of stations in the road network as N, calculating the allocation ratio from each starting point to different ending points based on historical OD data, which is denoted as W₁, and obtaining a predicted travel traffic volume Z=W₁O, Z∈R_{1×T×N} according to the allocation ratio;
S5.2.3, the path layer: screening, based on historical individual travel path data, the first M paths with the largest number of travels between each pair of ODs and their allocation ratio, which is denoted as W₂, obtaining predicted path traffic P=W₂Z, P∈R_{1×T×N×M} according to the allocation ratio, denoting pⱼ(t) as path traffic of path j at time t, j=1, . . . , N×M; t=1, . . . , T;
S5.2.4, the travel time layer: calculating, based on the historical individual travel data, travel time of each path, H={hⱼ(t), j=1, . . . , N×M; t=1, . . . , T}, and obtaining traffic of arriving at the ending point through the path j from time t, G={gⱼ(t)=pⱼ(t+hⱼ(t)), j=1, . . . , N×M; t=1, . . . , T}, G∈R_{1×T×N×M}; and
S5.2.5, the arrival station layer: aggregating the arrival traffic according to time to obtain arrival traffic û(t)=Σⱼ₌₁^{N×M}gⱼ(t) of each station at each time, which is denoted as the matrix Û∈R_{1×T}.

7. The method of predicting a holiday expressway travel traffic volume based on influence of weather factors according to claim 1, wherein the specific implementation method of Step S6 comprises the following steps:
S6.1, constructing an objective function, the calculation expression being:
$$min {\sum }_{t = 1}^{T} ( \hat{u} ( t ) - u ( t ) ) ;$$
and
S6.2, optimizing and solving the objective function constructed in Step S6.1 by using a reverse gradient propagation method, and adjusting the allocation ratios W₁ and W₂ to obtain the optimized travel traffic volume Z.
